(19) United States
(12) Patent Application Publication
(10) Pub. No.: US 2018/0086492 A1
(43) Pub. Date: Mar. 29, 2018

(54) FOLDABLE CHUTE

(71) Applicants: Larry V. Weathers, North Charleston, SC (US); Linda H. Weathers, North Charleston, SC (US)

(72) Inventors: Larry V. Weathers, North Charleston, SC (US); Linda H. Weathers, North Charleston, SC (US)

(21) Appl. No.: 15/711,079

(22) Filed: Sep. 21, 2017

Related U.S. Application Data
(60) Provisional application No. 62/399,516, filed on Sep. 26, 2016.

(51) Int. Cl. B65B 67/04; B65F 1/10; B65F 1/14

(52) U.S. Cl. CPC B65B 67/04; B65F 1/1415; B65F 1/10

(57) ABSTRACT

A foldable chute deployable in a bag for placing debris into the bag may include an outer portion residing predominantly outside of the bag when the foldable chute is deployed in the bag. The outer portion may include a chutefront having a leading edge with a pair of side edges, and a pair of support sides foldably connected to the chutefront at the pair of side edges. The foldable chute may further include an inner portion which may reside predominantly inside of the bag when deployed, may connect to the outer portion and may include a pair of retaining sides associated with the pair of support sides. Each retaining side may include a chuteback edge formed at a chute angle measured between the chuteback edge and a line defined by the side edge of the associated support side when foldable chute is in a flattened state.

### REFERENCE TO RELATED APPLICATION

This application claims priority to U.S. Provisional Patent Application No. 62/399,516 filed on Sep. 26, 2016, the entire contents of the provisional application being incorporated herein by reference.

### BACKGROUND

Many individuals struggle with placing large amounts of debris, such as lawn waste, into one or more bags. Generally, the opening in the bag is too small to accommodate the tools used to fill the bag (e.g. a rake, a shovel, etc.) and/or the bag collapses while the user is attempting to fill the bag, both of which may make it difficult to fill the bag with debris. For example, when a user of a paper lawn bag wishes to fill the bag with lawn waste (e.g. leaves, branches, twigs, etc.), the user may begin filling the paper lawn bag by hand or otherwise carefully placing small quantities of lawn waste into the bag to avoid deforming/closing the paper lawn bag until the volume of waste within the paper lawn bag holds the paper lawn bag open, which is not desirable. Further, even after the paper lawn bag is partially full, the opening in the bag may not be large enough for the user to easily fill it with a rake or other tool that is larger than the opening.

To currently address the difficulty of filling waste bags, users may purchase external leaf chutes, or some other type of mechanism that facilitates placing leaves into bags. However, these devices have their drawbacks. Some do not work well with paper bags because paper bags tend to rip when deployed in a trashcan. Others, like conventional leaf chutes, do not work well in practice because, among other things, the leading edge is not as large as a typical rake and/or the leading edge of the chute does not stay in contact with the ground when the chute is laid down, which allows debris to go underneath the chute. For example, FIG. 1A herein provides a lawn bag that is supported by a foldable support sleeve. The foldable support sleeve is not any wider than the bag in which it is deployed, so a user may have difficulty filling it with a conventional rake. Further, when the bag and foldable support sleeve are laid down on the ground such that the open portion of the bag and foldable support sleeve face a pile of debris (not shown), a user may rake debris underneath the bag when the attempting to rake debris into the open portion. What is needed is a device that works well with bags made of a variety of different materials, that resists collapsing when deployed, that is collapsible for easy storage, that is easily deployed for use within a bag, that has a leading edge that is wide enough to be easily filled by tools used to gather the debris, and that includes a leading edge that maintains contact with the ground so that debris does not easily slide underneath it when the bag is being filled.

### SUMMARY

According to an implementation, described herein, a foldable chute that may be deployed in a bag for placing debris into the bag may include an outer portion that resides predominantly outside of the bag when the foldable chute is deployed in the bag. The outer portion may include a chutefront having a leading edge and a pair of side edges, and a pair of support sides foldably connected to the chutefront at the pair of side edges. The foldable chute may further include an inner portion connected to the outer portion, the inner portion residing predominantly inside of the bag when the foldable chute is deployed in the bag. The inner portion may include a pair of retaining sides associated with the pair of support sides, each of the pair of retaining sides having a chuteback edge formed at a chute angle measured between the chuteback edge and a line defined by the side edge, of the support side, of the pair of support sides, with which the retaining edge, of the pair of retaining edges, is associated, the chute angle being measured when the foldable chute is in a flattened state. The chute angle may cause a lift angle to be formed between the outer portion and inner portion when the foldable chute is deployed in the bag. The leading edge of the chutefront may be from about 2 feet to about 5 feet wide, preferably about 3 feet wide. The chutefront may further include an inside edge opposite the leading edge. The inside edge may be from about 1 foot to about 2 feet wide. The foldable chute may further include a chuteback extending from the inside edge of the chutefront. The chuteback may be connected to the retaining sides. Additionally, or alternatively, the chuteback may not be connected to the retaining sides. The chute angle may be from about 5 degrees to about 35 degrees, preferably from about 10 degrees to about 25 degrees. The retaining sides may be foldably connected to the pair of support sides. The foldable chute may further include a pair of retainers associated with the pair of support sides. The foldable chute may further include a securing side and/or a handle. The foldable chute may further include a connector to connect the foldable chute to the bag, a receptacle associated with the bag, or a support sleeve associated with the bag. The foldable chute may be formed from one or more of cardboard, polyethylene, polypropylene, polyester, PVC, or stainless steel.

According to another implementation, described herein, a foldable chute that may be deployed in a bag for placing debris into the bag may include an outer portion that resides predominantly outside of the bag when the foldable chute is deployed in the bag. The outer portion may include a chutefront having a leading edge, an inside edge opposite the leading edge and narrower than the leading edge, and a pair of side edges. The outer portion may further include a pair of support sides foldably connected to the chutefront at the pair of side edges. The foldable chute may further include an inner portion connected to the outer portion, the inner portion residing predominantly inside of the bag when the foldable chute is deployed within the bag. The inner portion may include a pair of retaining sides associated with the pair of support sides. Each of the pair of retaining sides may have a chuteback edge formed at a chute angle of from about 10 degrees to about 25 degrees measured between the chuteback edge and a line defined by the side edge, of the support side, of the pair of support sides, with which the retaining edge, of the pair of retaining edges, is associated when the foldable chute is in a flattened state. The chute angle may cause a lift angle to be formed between the outer portion and inner portion when the foldable chute is deployed in the bag. The foldable chute may further include a pair of securing sides and a pair of retainers.

According to another implementation, described herein, a foldable chute that may be deployed in a bag for placing debris into the bag may include an outer portion that resides predominantly outside of the bag when the foldable chute is deployed in the bag. The outer portion may include a chutefront having a leading edge with a width of about three feet, an inside edge with a width of about sixteen inches and a pair of side edges. The outer portion may further include a pair of support sides foldably connected to the chutefront at the pair of side edges. The foldable chute may further include an inner portion connected to the outer portion. The inner portion may reside predominantly inside of the bag when the foldable chute is deployed within the bag. The inner portion may include a pair of retaining sides associated with the pair of support sides. Each of the pair of retaining sides may have a chuteback edge formed at a chute angle of from about 10 degrees to about 25 degrees measured between the chuteback edge and a line defined by the side edge, of the support side, of the pair of support sides, with which the retaining edge, of the pair of retaining edges, is associated. The chute angle may be measured when foldable chute is in a flattened state. The chute angle may cause a lift angle to be formed between the outer portion and the inner portion when the foldable chute is deployed in the bag. The foldable chute may be made from a single piece of material.

### BRIEF DESCRIPTION OF THE DRAWINGS

FIG. 1A illustrates an example environment, including prior art, in which the apparatus, system, method and/or technology may be implemented, and FIG. 1B illustrates a non-limiting example of the apparatus, system, method and/or technology, described herein implemented within the example environment of FIG. 1A.

FIG. 2 illustrates an example foldable chute.

FIGS. 3A and 3B illustrate the example foldable chute of FIG. 2 in a deployed state.

FIG. 4 illustrates another example foldable chute.

FIG. 5A illustrates the example embodiment of the foldable chute of FIG. 4 in a deployed state,

FIG. 5B illustrates a modified version of the example foldable chute of FIG. 4 in a deployed state, and

FIG. 6 illustrates the example environment of FIG. 1B where the foldable chute, support sleeve and lawn bag have been laid on the ground to allow debris to be raked into the bag.

### DETAILED DESCRIPTION

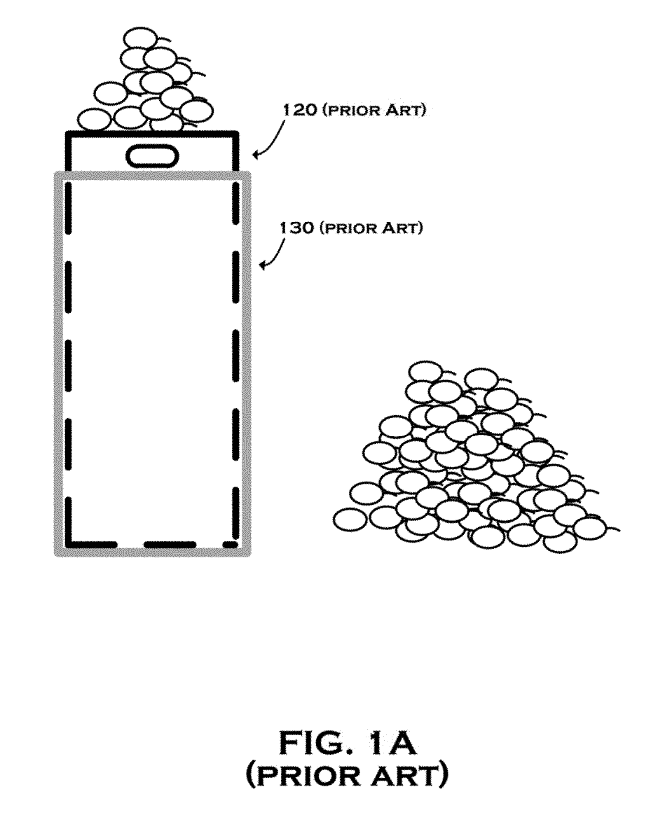

FIGS. 1A through 6 are attached hereto and incorporated by reference herein. The following detailed description refers to the accompanying FIGS. 1A through 6. The same reference numbers in different figures may identify the same or similar elements. The components illustrated in FIGS. 1A through 6 are provided for explanatory purposes only, and the disclosure herein is not intended to be limited to the components provided therein. There may be additional components, fewer components, different components, or differently arranged components than illustrated in FIGS. 1 through 6. Also, in some implementations, one or more of the components of the foldable chute may perform one or more functions described as being performed by another one or more of the components of the foldable chute.

An device, apparatus, method, system and/or technology, as described herein, may include a foldable chute (hereinafter “chute”) that may be used with a variety of different bags (e.g., lawn waste bags, trash bags, etc.) made of a variety of materials (e.g. paper, plastic, cardboard, biodegradable materials, metals, compostable materials, etc.) and may be used with a variety of different support devices to support the bags. For example, the chute may be placed within a lawn bag which a user wishes to fill with lawn waste (e.g. leaves, twigs, grass, mulch, etc.). The lawn bag may (or may not) be supported by one or more support devices (e.g. trashcans, wire frames, sleeves, etc.), and the chute may connect to the support device. For example, the lawn bag may be supported by a foldable support sleeve, such as that described in the Background section in connection with FIG. 1A, and the chute may connect (e.g. slip fit, a connector such as a clip, a clamp, hook and loop fasteners, loop with closure, etc., staples, interlocking folds, etc.) to the foldable support sleeve. The chute may permit the user to rake debris into the chute opening and/or into the bag. Additionally, or alternatively, the user may lay the bag, support device, and chute on the ground to rake the debris into the chute and may then pick up the bag, support and chute and allow the debris to slide into the bag by force of gravity. Additionally, or alternatively, a user may use the chute to scoop debris directly from the ground into the bag.

The chute may be in a first, folded, collapsed and/or compact state to enable the chute to be stored, shipped and/or packaged. The chute may be partially unfolded into a second, pre-deployed state to enable the chute to be easily inserted into the bag and/or into a support device. Additionally, or alternatively, the chute may be inserted into the bag and/or support device in the first, folded and/or compact state. When in the pre-deployed state, the chute may be configured such that the chute has a cross section that is smaller than the opening of the bag, the support device, and/or whatever the chute is inserted within. The chute may be unfolded or configured further into a third, deployed state when the user wishes to fill the bag with debris.

The chute may include an outside portion, which resides predominantly (e.g. at least 50%) outside of a bag when the chute is deployed in a bag, and an inside portion, which resides predominantly inside of the bag when the chute is deployed in a bag. The outside portion may include a chutefront, one or more support sides and/or one or more retaining sides. A user may rake debris up the chutefront, and the support sides and/or retaining sides may prevent the debris from falling off of the chutefront and back to the ground. The chutefront may include a leading edge which may reside opposite the inside portion. The leading edge may be placed on the ground when the chute is deployed in a bag and the bag and chute are laid on the ground to collect debris. The chutefront may include an inside edge connected to the inside portion. The inside edge may be narrower than the leading edge and may, for example, correspond to a dimension (e.g. length, width, radius, etc.) of the bag/receptacle/support within which it is placed.

The inside portion may include a chuteback and one or more retaining sides. The chuteback may be connected to the inside edge of the chutefront. The chuteback may have two lift edges that may be formed at an angle from a line along the sides of the chutefront. The angle between the line along the edges of the chutefront and the lift edges may cause a lift angle between the chutefront and the chuteback. The lift angle may ensure the leading edge maintains contact with the ground when the leading edge is placed on the ground, which may prevent debris from sliding underneath the leading edge of the chute.

The chute may be used with a wide variety of bags, including lawn bags (e.g. paper, plastic, fabric, etc.) in a wide variety of sizes (e.g. 5 gallon, 30 gallon, 100 gallon, etc.). The chute may be manufactured to have a wide variety of cross sections (e.g. square, rectangle, pentagon, etc.) to accommodate the needs of different users who wish to use different types of bags and/or store different types of debris within bags.

The embodiments, described herein, correspond to a chute used for lawn waste bags for explanatory purposes. Additionally, or alternatively, the chute may be used with any other type of bag in addition to or instead of lawn-waste bags. In a non-limiting example, a user may use the chute to assist the user when filling a kitchen trash bag, industrial liner, etc.

FIG. 1B illustrates a non-limiting example of the apparatus, system, method and/or technology, described herein implemented within an example environment. For example, environment 100 may include a foldable chute 110 (hereinafter “chute 110”), a support sleeve 120, a lawn bag 130 (e.g. a 10, 20, 30, 50 gallon paper bag, plastic bag, etc.) and/or yard debris 140 (e.g. leaves, twigs, mulch, etc.). Support sleeve 120 may fit within lawn bag 130 and may include one or more components associated with supporting lawn bag 130 while the user fills lawn bag 130. Chute 110 may fit within and/or connect to (e.g. slide fit, clips, clamps, mechanical fasteners, interlocking folded connection, etc.) to support sleeve 120. Additionally, or alternatively, chute 110 may fit within and/or connect directly to lawn bag 130 without support sleeve 120. A user may place the chute 110, support sleeve 120 and lawn bag 130 on the ground so that a leading edge 111 of chute 110 lies on the ground in order to rake, scoop, or otherwise fill lawn bag 130 with debris 140.

Chute 110 may be formed from a material (e.g., a metal, composite, plastics, wood, fiberglass, cardboard, biodegradable materials, compostable materials, etc.) of sufficient strength and rigidity to support the static and/or dynamic loads (e.g., forces, torques, tensions, compressions, stresses, strains, etc.) imparted on chute 110 by the user (e.g., when folding chute 110, when inserting chute 110 into support sleeve 120 and/or lawn bag 130, when removing chute 110 from support sleeve 120 and/or lawn bag 130, when placing lawn waste 110 into lawn bag 130, etc.), support sleeve 120, lawn bag 130 and/or debris 140. Chute 110 may also, or alternatively, be formed from and/or be lined by a material (e.g., stainless steel, composite, one or more plastics (polyethylene, polypropylene, pvc, polyesters, etc.), ceramic, fiberglass, etc.) of sufficient corrosion resistance and toughness to withstand exposure to water, solvents, sunlight, and various types of waste. Chute 110 may be formed from a material or materials of sufficient ductility (e.g. cardboard, plastics, etc.) to permit 2 or sides to be foldably connected without failing when the 2 or more sides are formed from a single piece of material. Chute 110 may be composed of one or more pieces, which may be joined together using known methods of permanent and/or detachable attachment (e.g. welding, gluing, hinged connections, taped, etc.). The types and shapes of chute 110 are not intended to be limited to those shown in the figures.

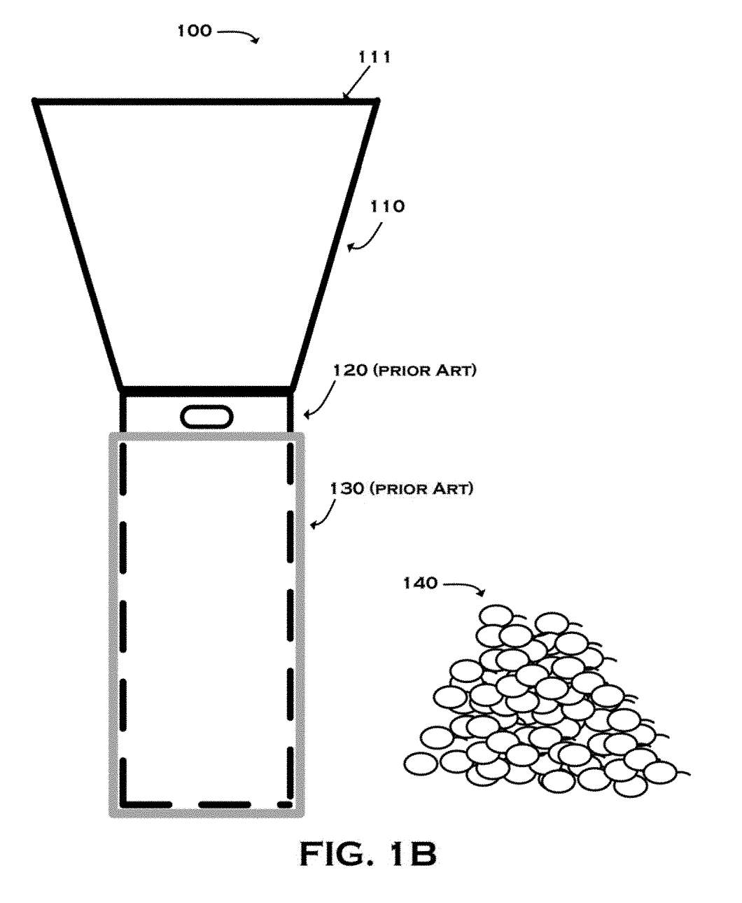

FIG. 2 illustrates example chute 110 shown in a flat, unfolded and/or substantially flat state (hereinafter a “flattened state”). As shown in FIG. 2, chute 110 may include an outside portion 201 and an inside portion 202. Outside portion may include a chutefront 210 and one or more sides 220. Chutefront 210 may define a leading edge 111, an inside edge 211 and one or more side edges 212. Handles 225 may be formed as apertures of any shape within and/or through sides 220. Additionally, or alternatively, handles 225 may be formed in connection with any other side/component associated with chute 110. Additionally, or alternatively, handles 225 may be formed by additional components (e.g. knobs, pulls, rope, etc.) that are joined to chute 110 by way of mechanical attachment (e.g. rivets, fasteners, glue, welding, etc.). Inside portion 202 may include a chuteback 230 and two retaining sides 240. The components illustrated in FIG. 2 are provided for explanatory purposes only, and the disclosures herein are not intended to be limited to the components reflected in the drawings. There may be additional components, fewer components, different components, or differently arranged components than illustrated in FIG. 2. For instance, although chute 110 depicted in FIG. 2 has two sides 220 and two retaining sides 240, chute 110 may have more or less than two sides 220 and/or retaining sides 240. Also, in some implementations, one or more components of chute 110 may perform one or more functions described as being performed by another one or more of the components of chute. Additionally, chute 110 may include fasteners (e.g. clips, clamps, hook-and-loop fasteners, snaps, loops with closures, etc.) (not shown) that may be used to connect chute 110 to a bag and/or support device in connection with which the chute 110 is used. While dimensions may be included herein for certain embodiments, the scope of the disclosure herein is not limited to the dimensions discussed herein. The foldable chute may be made in any dimension to fit any bag, receptacle, application, etc.

Chute 110 may be foldable between chutefront 210 and sides 220, between chutefront 210 and chuteback 230, between sides 220 and retaining sides 240, and/or between chuteback 230 and retaining sides 240 to assist the user in using chute 110. When chute 110 is unfolded, as depicted in FIG. 2, chute 110 may be a flat piece of material. When chute 110 is deployed within a bag and/or support device, inside portion 202 may reside predominantly (e.g. 50%, 75%, 90%, 100%, etc.) within the bag and/or support device, and outside portion 201 may reside predominantly (e.g. 50%, 75%, 90%, 100%, etc.) outside of the bag and/or support sleeve. When deployed and/or pre-deployed, chutefront 210 may form an angle (e.g. 45 degrees, 90 degrees, 120 degrees, etc.) with sides 220, and chuteback 230 may form an angle with retaining sides 240 (e.g. 45 degrees, 90 degrees, 120 degrees, etc.). Additionally, or alternatively, when chute 110 is deployed and/or predepolyed, chutefront 210 may form a lift angle with chuteback 230 (e.g. 10 degrees, 20 degrees, 50 degrees, etc.).

Chutefront 210 may provide the surface over which debris (e.g. lawn waste, trash, construction waste, etc.) may be transferred when a user uses chute 110 to place debris into a bag, such as bag 130. Chutefront 210 may define a leading edge 111 and an inside edge 211. Leading edge 111 may be placed on the ground when a user wants to use chute 110 to slide debris from the ground into a bag (e.g. such as when raking a pile of leaves on the ground into a bag, etc.). Inside edge 211 may be located between chutefront 210 and chuteback 230. Inside edge 211 may be shorter than leading edge 111 when chute 110 is designed to be used with a tool (e.g. shovel, rake, broom, etc.) that is larger than the width of the bag into which debris is placed. For example, conventional lawn bags may include a leading edge that may be about three feet wide (i.e. 2 to 5 feet), and inside edge that may be about one and one-half feet long (i.e. 12 inches, 16 inches, 18 inches, 2 feet, etc.). Chutefront 210 may be connected to sides 220 and may define side edges 212 between chutefront 210 and sides 220.

Sides 220 may be connected to chutefront 210 and retaining sides 240. As depicted in FIG. 2, sides 220 may be connected to chutefront 210 and retaining sides 240 for the entire length between chute 220 and retaining sides 240. Additionally, or alternatively, sides 220 may be connected to chutefront 210 and retaining sides 240 for some portion less than the length between sides 220 and chutefront 210 and retaining sides 240. When deployed, sides 220 may prevent debris from falling off of chutefront 210 as debris travels across chutefront 210 from leading edge 111 to inner edge 211, which may assist a user in placing debris into a bag. A user may connect a bag, support device, etc. to chute 110 by joining (e.g. using a clamp, a clip, mechanical fasteners, etc.) sides 220 to the bag. Additionally, or alternatively, a user may connect a bag and/or support device to chute 110 at the retaining sides 240 and/or any other portion of chute.

Chuteback 230 may be connected to chutefront 210 at inner edge 211. Chuteback 230 may fit within a bag and/or support device. Chuteback 230 may define two chute edges 231 which may extend from side edges 212 at inside edge 211. In FIG. 2, chute edge 231 is adjacent to chuteback edge 241 because chute 110 is shown in a flattened position in FIG. 2. When deployed, chute edge 231 (the edge of chuteback 230) separates from chuteback edge 241 (the edge of retaining side 240) as discussed herein. Accordingly, chute edge 231 may be an edge that does not connect retaining sides 240 to chuteback 230 (e.g. when lift angle is less than 180 degrees/when chute angle is greater than zero) in order to permit chuteback 230 to separate from retaining sides 240 when chute 110 is deployed in a bag.

Retaining sides 240 may be associated with (e.g. connected to, connectable to, extending from, etc.) sides 220 and may fit within a bag and/or support device. When chute 110 is deployed in a bag, retaining sides 240 may maintain the bag in an open position. Additionally, or alternatively, retaining sides 240 may maintain debris within the chute 110 and/or bag as it is being placed into the bag via the chute 110. Chuteback edge 241 of retaining sides 240 (e.g. the edge adjacent to chuteback, if any, when chute is in a flattened state) may be opposite another edge of retaining side 240, which opposite edge may be parallel to chuteback edge (for instance, so that the width of the retaining side, as measured between the chuteback edge 241 and opposite edge, corresponds to a dimension of the rectangular cross section of a conventional paper lawn bag of about 12 inches by about 16 inches). Retaining sides 240 may be any size or shape and may occupy some and/or all of a dimension associated with a bag and/or receptacle.

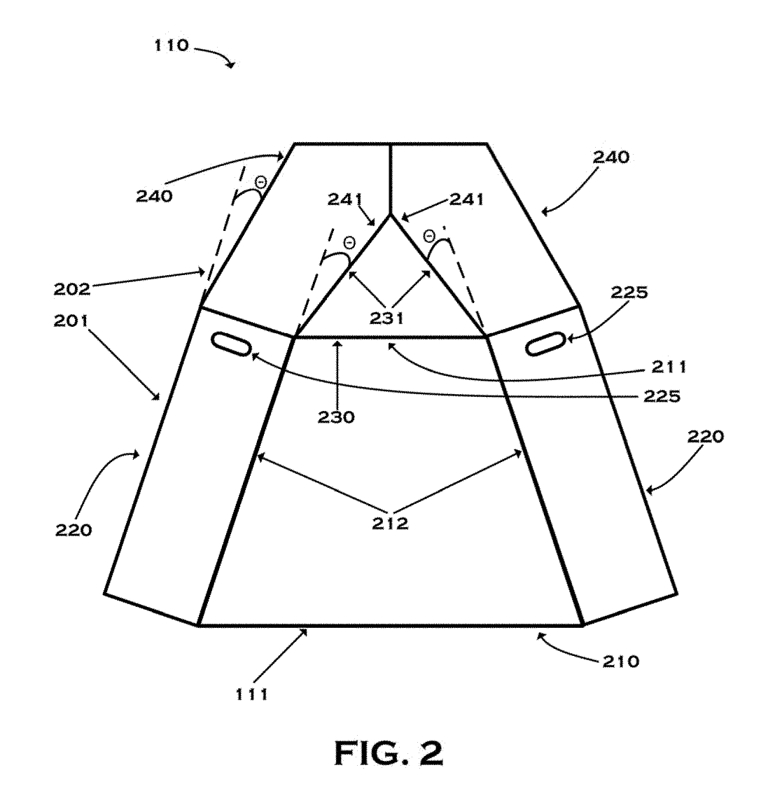

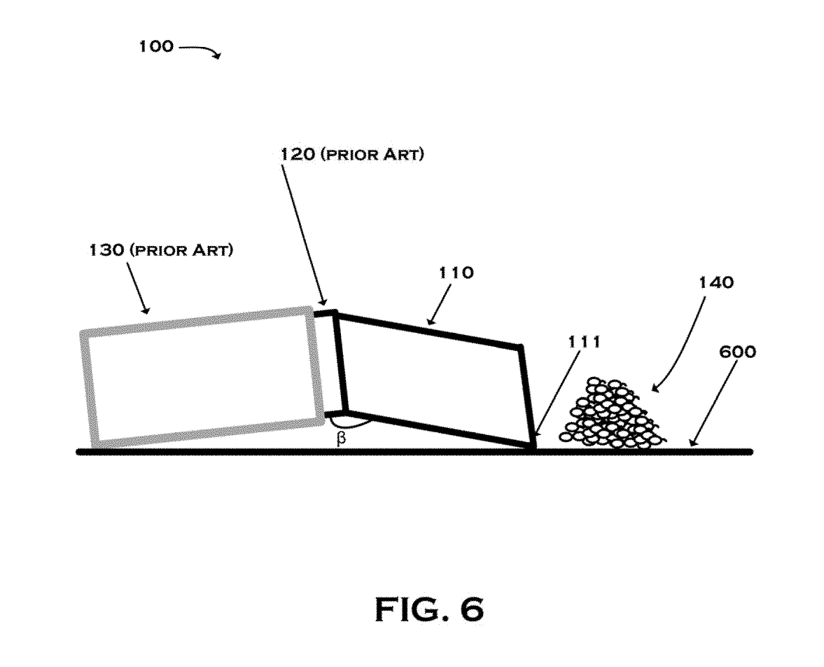

A chute angle Θ may be defined by the angle between chuteback edge 241 and a line (the dashed line) extending from side edges 212 when chute 110 is in a flattened stated and may be greater than zero so that lift angle β, which is further discussed herein, is less than 180 degrees. Chute angle Θ may, ideally, be greater than zero but less than about 45 degrees, preferably from about 5 degrees to about 35 degrees, more preferably from about 10 degrees to about 25 degrees. Increasing chute angle Θ may decrease lift angle β (increasing the amount of lift, as lift angle is 180 degrees when flat), which is depicted in FIG. 3B. If lift angle β is desired to be 180 (i.e. a flat funnel when deployed), then chute angle Θ may be zero degrees when chute is in a flattened state. In this state, chuteback 230 and retaining sides 240 may be connected. However, when lift angle β is zero, the leading edge of chutefront may easily lose contact with the ground, allowing debris to easily slide under leading edge 111. A lift angle β of less than 180 degrees may maintain the leading edge 111 of chutefront 210 in contact with the ground when the chute 110 is placed on the ground, as shown in FIG. 6. Decreasing the lift angle β (below 180 degrees), may further drive the leading edge 111 toward the ground to maintain contact with the ground and cause a “ramp-like” effect to be imparted to chutefront 210. While this ramp-like effect causes leading edge to maintain contact with the ground, it also requires elevating the debris, etc., being pushed (e.g. raked, brushed, etc.) across the chutefront in order for the debris to be placed into the bag via chutefront 210. However, this elevation also helps maintain the debris, etc., in the bag after it has been placed there (i.e. because it resides at or below the inside edge 225 of chutefront when the chute 110 and bag are placed on the ground).

FIGS. 3A and 3B illustrate the non-limiting example embodiment of a foldable chute of FIG. 2 in a deployed state. As depicted in FIG. 3A, when chute 110 is folded into a deployed position, chutefront 210 may reside at an angle (e.g. 45 degrees, 90 degrees, 120 degrees, etc.) with sides 220, which may be approximately the same as, or different from, the angle between chuteback 230 and retaining sides 240. FIGS. 3A and 3B depict the angle between the chutefront 210 and the sides 220 to be 90 degrees. If the angle between chutefront 210 and sides 220 is decreased (i.e. the sides are folded further from the unfolded position depicted in FIG. 2, decreasing the cross section of chute 110 until, at most, sides 220 lie flat on chutefront 210), the chute 110 may enter a pre-deployed position which has a smaller cross section, which may make it easier to place chute 110 within a bag and/or a support device. The user may unfold chute 110 from a pre-deployed position (not shown) to the deployed position depicted in FIGS. 3A and 3B after the chute is placed within a bag and/or support device. Placing the chute 110 in a deployed position in a bag or support device may connect chute to the bag or support device by causing chute 110 to occupy the same and/or similar cross section as the bag and/or support device within which chute 110 is deployed. Additionally, or alternatively, chute 110 may be connected to bag and/or support device using known mechanical attachment devices (clamps, clips, magnets, zippers, hook and loop fasteners, snaps, loops with closures, etc.).

FIG. 3B depicts the lift angle β that results from the chute angle Θ depicted in FIG. 2. The lift angle may be the angle between the inner portion 202 and outer portion 201 and may maintain the leading edge 111 of chute 110 on the ground when the leading edge 111 is placed on the ground, which may assist the user when the leading edge 111 is placed on the ground to transfer debris into a bag by preventing debris from sliding under leading edge 111. Lift angle β may be less than 180 degrees (i.e. flat) and may generally range from about 135 degrees to about 175 degrees. Lift angle β may vary based upon, for instance, the needs of the user, the size of the receptacle, the type of objects being placed into a bag via foldable chute, etc.

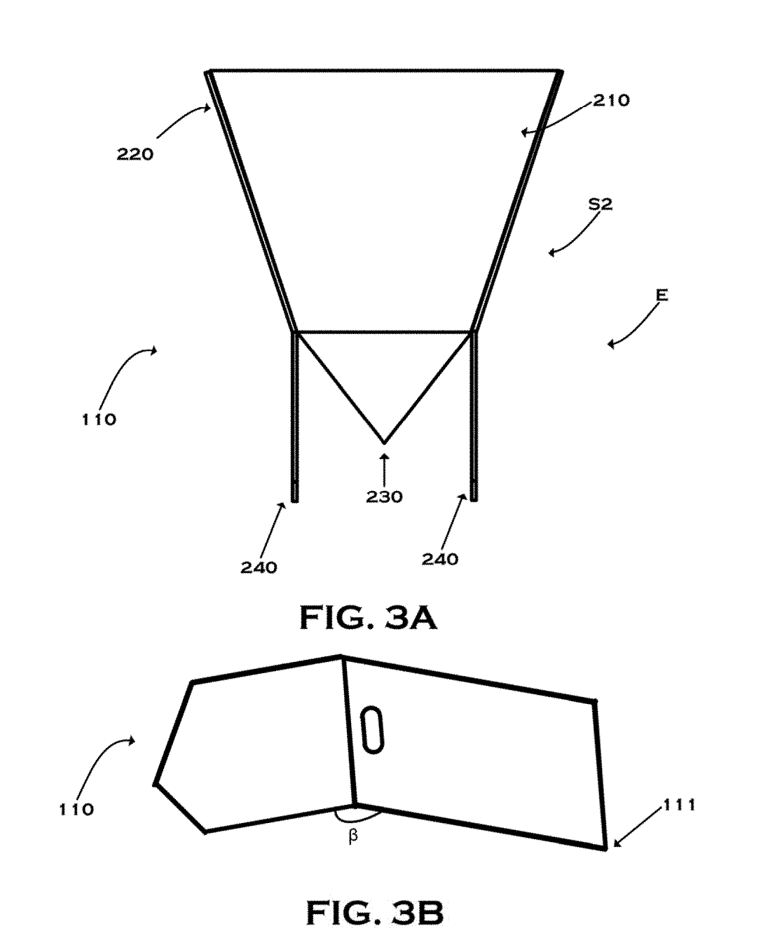

FIG. 4 illustrates another non-limiting example of a foldable chute. Foldable chute 400 (hereinafter “chute 400”) may include many of the same and/or similar components of chute 110 depicted in FIG. 2. Chute 400 may include an outside portion 401 and an inside portion 402. Outside portion may include a chutefront 410, two sides 420, and two retainers 450. Chutefront 410 and two sides may perform similarly to chutefront 210 and sides 220 of chute 110 described in FIG. 2. Inside portion 402 may include a chuteback 430, two retaining sides 440 and two securing sides 460. Chuteback 430 and retaining sides 440 may perform similarly to chuteback 230 and retaining sides 240 of chute 110 described in FIG. 2. Chuteback 430 may have two sides, similar to chuteback 230 of FIG. 2, that may be formed at an angle from the line that passes through the seam between chutefront 410 and sides 420, which angle may maintain the leading edge of chute 400 on the ground.

Retainers 450 may be connected to sides 420 and/or securing sides 460 and may retain debris in chute 400 and/or a bag when a user is filling the bag. For example, when the leading edge is placed on the ground, debris may move across the chutefront 410, retainers 450 may prevent the debris from escaping the chute 400 by preventing debris from going over the sides 420. In one embodiment, retainers 450 overlap securing sides 460 but are not connected to securing sides 460. In this configuration, when the securing sides 460 are folded, the portion of retainers 450 which overlap securing sides 460 are contacted by securing sides 460, which may assist the user in deploying the chute 400 by requiring the upper portion 401 to be folded when the lower portion 402 is folded. Also in this configuration, the portion of retainers 450 that overlaps securing sides 460 may reside within a bag, similar to the components of inside portion 402, when chute 400 is deployed in a bag. Alternatively, retainers 450 may not overlap securing sides 460 and/or may not extend into the bag when deployed. Retainers 450 may extend the entire length or a portion of the length of sides 420.

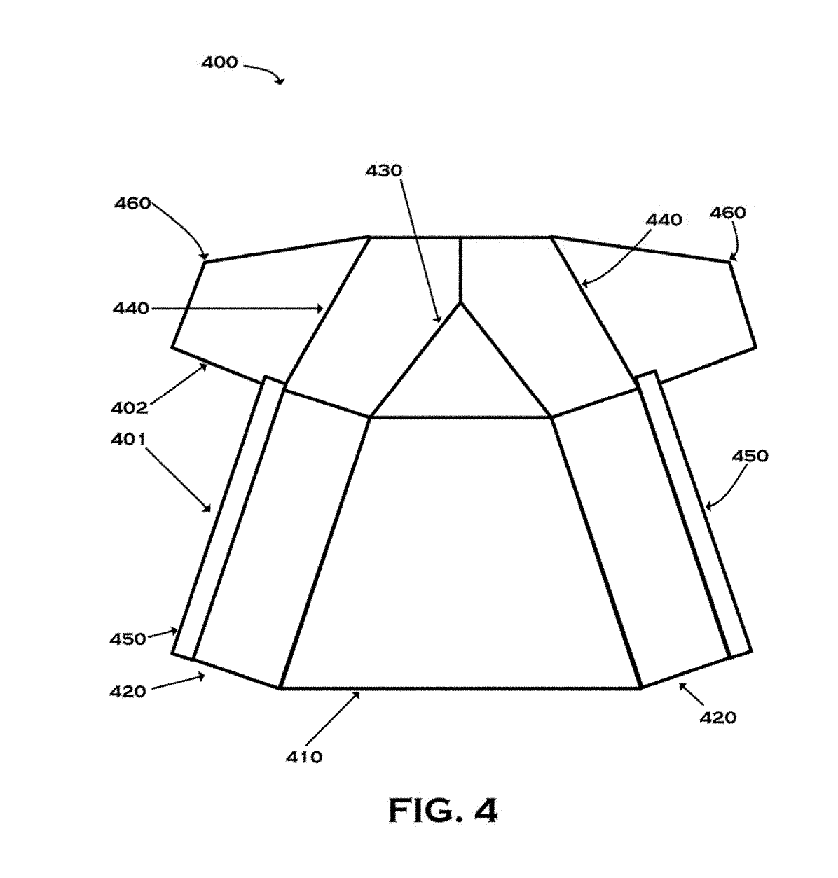

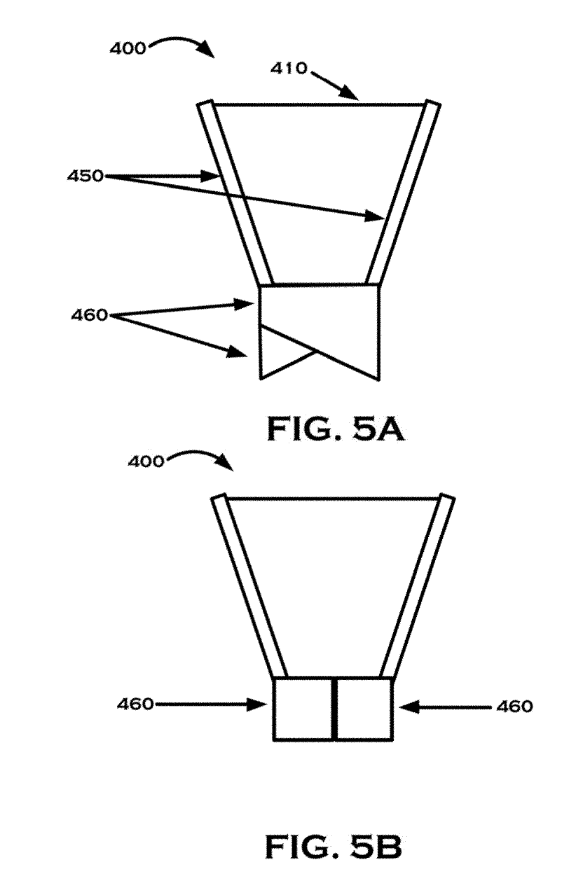

Securing sides 460 may be connected to retaining sides 440 and/or retainers 450 and may fit within a bag and/or support device. When chute 400 is deployed in a bag, securing sides 460 may, along with chuteback 430 and retaining sides 440, maintain the bag in an open position. For example, securing sides 460 may come in contact with and/or overlap one another when chute 400 is deployed, as depicted in FIGS. 5A and 5B. Additionally, or alternatively, securing sides 460 may maintain debris within the chute 400 and/or bag as it is being placed into the bag.

FIG. 5A illustrates the non-limiting example embodiment of the foldable chute of FIG. 4 in a deployed state, and FIG. 5B illustrates a modified version of the non-limiting example embodiment of the foldable chute of FIG. 4 in a deployed state. As depicted in FIG. 5A, chute 400 may be folded into a deployed position, where chutefront 410 may reside at an angle (e.g. 45 degrees, 90 degrees, 120 degrees, etc.) with sides 420 (not shown), and/or sides 420 may reside at an angle with retainers 450. For example FIGS. 5A and 5B depict retainers 450 oriented at an angle of 90 degrees to sides 420, and sides 420 at an angle of 90 degrees to chutefront 410. In this position, retainers 450 may maintain debris in the chute 440 as it being used. Alternatively, retainers 450 may not reside at an angle with sides 420. In this configuration, retainers provide an additional surface which may further restrain debris traversing the chute by extending sides 420. As the angle between chutefront 410 and sides 420 is decreased (i.e. the sides 420 and retainers 450 are folded further from the unfolded position depicted in FIG. 4), the chute 400 may enter a pre-deployed position which has a smaller cross section, which may make it easier to place chute 400 within a bag and/or a support device. The user may unfold chute 400 from a pre-deployed position (not shown) to the deployed position depicted in FIGS. 5A and 5B after the chute is placed within a bag and/or support device. Placing the chute 400 in a deployed position in a bag or support device may connect chute to the bag or support device by causing chute 400 to occupy the same and/or similar cross section as the bag and/or support device within which chute 400 is deployed. Additionally, or alternatively, chute 400 may be connected to bag and/or support device using known mechanical attachment devices (clamps, clips, magnets, zippers, etc.), which may be placed on any component of chute 400. In the configuration depicted in FIG. 5A, retainers 460 may overlap one another when chute 400 is deployed. Additionally, or alternatively, as shown in FIG. 5B, retainers 460 may abut one another when chute 400 is deployed. Additionally, or alternatively, retainers may not come in contact with one another when chute 400 is deployed. In the embodiments depicted in FIGS. 5A and 5B, retainers 460, sides 440 and chuteback 430, when deployed, may defined a cross section that is approximately equal to the cross section of the bag and/or support device within which chute 400 is deployed.

FIG. 6 illustrates the example environment 100 of FIG. 1B where the foldable chute 110, support sleeve 120 and lawn bag 130 have been laid on the ground 600 to allow debris 140 (e.g. lawn debris, although it could be any material a user desires to place in the bag 130) to be raked into the bag 130 and/or support sleeve 120. As depicted in FIG. 6, lift angle β may cause leading edge 111 to maintain contact with the ground 600, which limits and/or prevents debris 140 from going under chute 110 when, for instance, debris is raked into the chute 110. Additionally, or alternatively, lift angle β may maintain other portions of the chute 110 (particularly the inside edge 225) above the ground, which requires debris 140 to be elevated across chute 110 as it is raked into the bag 130 and which also maintains debris 140 in the bag (e.g. limiting and/or preventing debris from spilling out over inside edge out of the bag).

The foregoing description provides illustration and description, but is not intended to be exhaustive or to limit the implementations to the precise form disclosed. Modifications and variations are possible in light of the above disclosure or may be acquired from practice of the embodiments. It will be apparent that the apparatus, systems, methods, technologies and/or techniques, as described above, may be implemented in many different forms of hardware in the implementations described herein and illustrated in the figures. The actual or specialized hardware and/or materials used to implement the apparatus, systems, methods, technologies and/or techniques is not limited to the embodiments; it should be understood that hardware and/or materials may be designed to implement the apparatus, systems, methods, technologies and/or techniques based on the description herein.

It should be emphasized that the terms “comprises”/“comprising” when used in this specification are taken to specify the presence of stated features, integers, steps or components but does not preclude the presence or addition of one or more other features, integers, steps, components, or other groups thereof.

No element, act or instruction used in the present application should be construed as critical or essential to the embodiments unless explicitly described as such. Also, as used herein, the articles “a” and “an” are intended to include one or more items and may be used interchangeably with “one or more.” Where only one item is intended, the term “one” or similar language is used. Further, the phrase “based on” is intended to mean “based, at least in part, on” unless explicitly stated otherwise.

While preferred embodiments of the invention have been shown and described, those skilled in the art will recognize that other changes and modifications may be made to the foregoing embodiments without departing from the scope and spirit of the invention. For example, specific shapes of various elements of the illustrated embodiments may be altered to suit particular applications. Additionally, the foldable chute may have more or less sides, handles, etc., and chute may be designed to be deployed at various angles without departing from the spin of the invention disclosed herein. Additionally, or alternatively, various components may be added to and/or subtracted from foldable chute without departing from the spirit of the invention. For example, and not limitation, foldable chute is referred to as having two, or a pair, of one or more components. In other embodiments, a single one of these components may be used and/or three or more may be used. Further, the embodiments disclosed herein may be used in different applications. For example, the embodiments disclosed herein may be used to support bags other than waste or lawn bags that may hold any type of material. It is intended to claim all such changes and modifications as fall within the scope of the disclosure herein and the equivalents.

What is claimed is:

1. A foldable chute that may be deployed in a bag for placing debris into the bag, the foldable chute comprising:
an outer portion that resides predominantly outside of the bag when the foldable chute is deployed in the bag, the outer portion including
a chutefront having a leading edge and a pair of side edges, and
a pair of support sides foldably connected to the chutefront at the pair of side edges;
an inner portion connected to the outer portion, the inner portion residing predominantly inside of the bag when the foldable chute is deployed in the bag, the inner portion including
a pair of retaining sides associated with the pair of support sides, each of the pair of retaining sides having a chuteback edge formed at a chute angle measured between the chuteback edge and a line defined by the side edge, of the support side, of the pair of support sides, with which the retaining edge, of the pair of retaining edges, is associated, the chute angle being measured when the foldable chute is in a flattened state;
wherein the chute angle causes a lift angle to be formed between the outer portion and inner portion when the foldable chute is deployed in the bag.

2. The foldable chute of claim 1, where the leading edge of the chutefront is from about 2 feet to about 5 feet wide.

3. The foldable chute of claim 1, where the leading edge of the chutefront is about 3 feet wide.

4. The foldable chute of claim 1, where the chutefront includes an inside edge opposite the leading edge, the inside edge being narrower than the leading edge.

5. The foldable chute of claim 4, where the inside edge is from about 1 foot to about 2 feet wide.

6. The foldable chute of claim 4 further including a chuteback extending from the inside edge of the chutefront.

7. The foldable chute of claim 6, where the chuteback is connected to the retaining sides.

8. The foldable chute of claim 6, where the chuteback is not connected to the retaining sides.

9. The foldable chute of claim 1, where the chute angle is from about 5 degrees to about 35 degrees.

10. The foldable chute of claim 1, where the chute angle is from about 10 degrees to about 25 degrees.

11. The foldable chute of claim 1, where the pair of retaining sides are foldably connected to the pair of support sides.

12. The foldable chute of claim 1 further including a pair of retainers associated with the pair of support sides.

13. The foldable chute of claim 1 further including a securing side.

14. The foldable chute of claim 1 further including a handle.

15. The foldable chute of claim 1 further including a connector to connect the foldable chute to the bag, a receptacle associated with the bag, or a support sleeve associated with the bag.

16. The foldable chute of claim 1 formed from one or more of the following:
cardboard,
polyethelyne,
polypropylene,
polyester,
PVC, or
stainless steel.

17. A foldable chute that may be deployed in a bag for placing debris into the bag, the foldable chute comprising:
an outer portion that resides predominantly outside of the bag when the foldable chute is deployed in the bag, the outer portion including
a chutefront having a leading edge, an inside edge opposite the leading edge and narrower than the leading edge, and a pair of side edges, and
a pair of support sides foldably connected to the chutefront at the pair of side edges;
an inner portion connected to the outer portion, the inner portion residing predominantly inside of the bag when the foldable chute is deployed within the bag and including
a pair of retaining sides associated with the pair of support sides, each of the pair of retaining sides having a chuteback edge formed at a chute angle of from about 10 degrees to about 25 degrees measured between the chuteback edge and a line defined by the side edge, of the support side, of the pair of support sides, with which the retaining edge, of the pair of retaining edges, is associated, the chute angle being measured when the foldable chute is in a flattened state;
wherein the chute angle causes a lift angle to be formed between the outer portion and inner portion when the foldable chute is deployed in the bag.

18. The foldable chute of claim 17 further including a pair of securing sides and a pair of retainers.

19. A foldable chute that may be deployed in a bag for placing debris into the bag, the foldable chute comprising:
an outer portion that resides predominantly outside of the bag when the foldable chute is deployed in the bag, the outer portion including
a chutefront having a leading edge with a width of about three feet, an inside edge with a width of about sixteen inches and a pair of side edges, and
a pair of support sides foldably connected to the chutefront at the pair of side edges;
an inner portion connected to the outer portion, the inner portion residing predominantly inside of the bag when the foldable chute is deployed within the bag and including
a pair of retaining sides associated with the pair of support sides, each of the pair of retaining sides having a chuteback edge formed at a chute angle of from about 10 degrees to about 25 degrees measured between the chuteback edge and a line defined by the side edge, of the support side, of the pair of support sides, with which the retaining edge, of the pair of retaining edges, is associated, the chute angle being measured when foldable chute is in a flattened state;
wherein the chute angle causes a lift angle to be formed between the outer portion and inner portion when the foldable chute is deployed in the bag.

20. The foldable chute of claim 19 made from a single piece of material.
